(19) United States
(12) Patent Application Publication
(10) Pub. No.: US 2015/0266464 A1
(43) Pub. Date: Sep. 24, 2015

(54) SLOW TORQUE MODULATION PERFORMED BY FAST ACTUATOR

(71) Applicant: FORD GLOBAL TECHNOLOGIES, LLC, DEARBORN, MI (US)

(72) Inventors: Bernard D. Nefcy, Novi, MI (US); Marvin P. Kraska, Dearborn, MI (US); Daniel S. Colvin, Farmington Hills, MI (US); Derek Taylor, Waterford, MI (US)

(73) Assignee: FORD GLOBAL TECHNOLOGIES, LLC, DEARBORN, MI (US)

(21) Appl. No.: 14/220,408

(22) Filed: Mar. 20, 2014

(51) Int. Cl. B60W 10/10; B60W 10/08; B60W 10/06

(52) U.S. Cl. CPC B60W 10/10; B60W 10/06; B60W 10/08; B60W 2510/0604; B60W 2510/0657; B60W 2510/083; B60W 2710/10

(57) ABSTRACT

A method for controlling torque modification during a gearshift includes modifying transmission input torque during the gearshift using an actuator having slower and faster responses to a request for slow input torque modification, fulfilling the request using the slower response provided the faster response is unable to fulfill the request, and fulfilling the request using the faster response, provided the faster response can provide the requested torque modification.

### BACKGROUND OF THE INVENTION

1. Field of the Invention

This invention relates generally to controlling torque modulation during a transmission gear change in response to a signal representing slow torque modulation, wherein the torque modulation is performed by a fast actuator.

2. Description of the Prior Art

When a transmission upshift is performed, inertia is transmitted through the powertrain to the driven vehicle wheels. But when a transmission downshift is performed, toque produced by the operative vehicle power source must be modulated and vehicle kinetic energy must be absorbed or dissipated. Preferably, in a hybrid electric vehicle kinetic energy is transmitted to the vehicle's powertrain where it can be regenerated and stored as electric energy in an onboard electric storage battery.

Use of slow torque modulation for torque reduction during gear shifting will be directed by a command signal toward the slow actuator, i.e., the power source having the slower response time to the signal for torque reduction. Use of the fast torque modulation for torque reduction will be directed by a command signal toward the faster actuator. Potential exists to capture energy from the faster actuator (using the electric machine in a modular hybrid powertrain). But since the slow torque modification is directed toward the slow actuator path, the opportunity to collect this energy may be reduced.

### SUMMARY OF THE INVENTION

A method for controlling torque modification during a gearshift includes modifying transmission input torque during the gearshift using an actuator having slower and faster responses to a request for slow input torque modification, fulfilling the request using the slower response provided the faster response is unable to fulfill the request, and fulfilling the request using the faster response, provided the faster response can provide the requested torque modification.

The method recovers more energy if the fast actuator is an electric machine, thereby compensating for lost energy during other gearshift events.

The method uses a slow torque modulation request to evaluate whether there is enough capability and authority in the fast actuator to perform the request. If there is sufficient capability/authority, then the fast actuator is used via to provide the request in enough time to satisfy the slow torque modulation request. Since the fast actuator responses faster to the request, sufficient time is available to evaluate this decision and perform the request.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a schematic diagram showing a modular hybrid electric powertrain for a motor vehicle;

FIG. 2 contains graphs showing the variation of powertrain parameters during a transmission gearshift in a hybrid electric vehicle;

FIG. 3 is flow diagram representing an algorithm for controlling transmission gearshift in a hybrid electric vehicle.

### DESCRIPTION OF THE PREFERRED EMBODIMENT

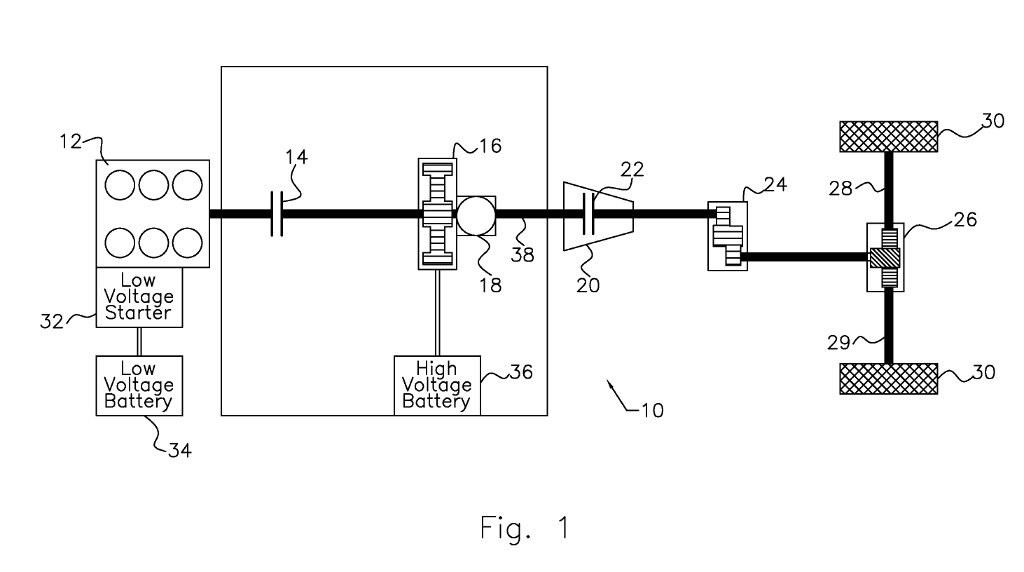

FIG. 1 illustrates a modular hybrid electric powertrain 10 that includes an internal combustion engine 12, engine disconnect clutch 14, electric machine or motor/generator 16, transmission hydraulic pump 18, torque converter 20, torque converter lock-up clutch 22, transmission gearing 24, final drive gearing 26, shafts 28, 29, and driven wheels 30. A low voltage starter 32, powered by a low voltage battery 34, cranks the engine while starting the engine 12 and producing sustained combustion. A high voltage battery 36 powers the electric motor/generator 16.

The torque converter 20 is a hydraulic coupling that produces a hydrokinetic drive connection between an impeller, which is driveably connected to the engine 12 when clutch 14 is closed, and a turbine, which is driveably connected to the driven wheels 30.

The torque converter lock-up clutch 22 alternately opens and closes a drive connection between the torque converter's turbine and the shaft 38.

A vehicle equipped with this powertrain 10 can produce electric drive and hybrid electric drive and can charge the battery 36 either by regenerative braking, i.e., recovering and converting kinetic energy of the vehicle during a braking event to electric energy that can be stored in battery 36, or by using the engine to charge battery 36.

During regenerative braking, torque is transmitted from the wheels 30 to the electric machine 16. To recoup most of the kinetic energy using regenerative braking, the torque converter clutch 22 should be kept locked while vehicle speed is slowing.

The control strategy coordinates operation of the torque converter clutch 22 and the electric machine 16 during a vehicle braking event, whether engine 12 is running or the engine is stopped. If engine 12 is running, its crankshaft is connected to the electric machine 16; therefore, the torque converter's impeller speed can not drop below the engine idle speed. If engine 12 is stopped, the electric machine 16 can be running at speeds lower than the nominal engine idle speed. If the transmission's hydraulic system line pressure is provided by the mechanical oil pump 18, the minimal impeller speed should be determined by the minimal pressure that the pump should generate in this case.

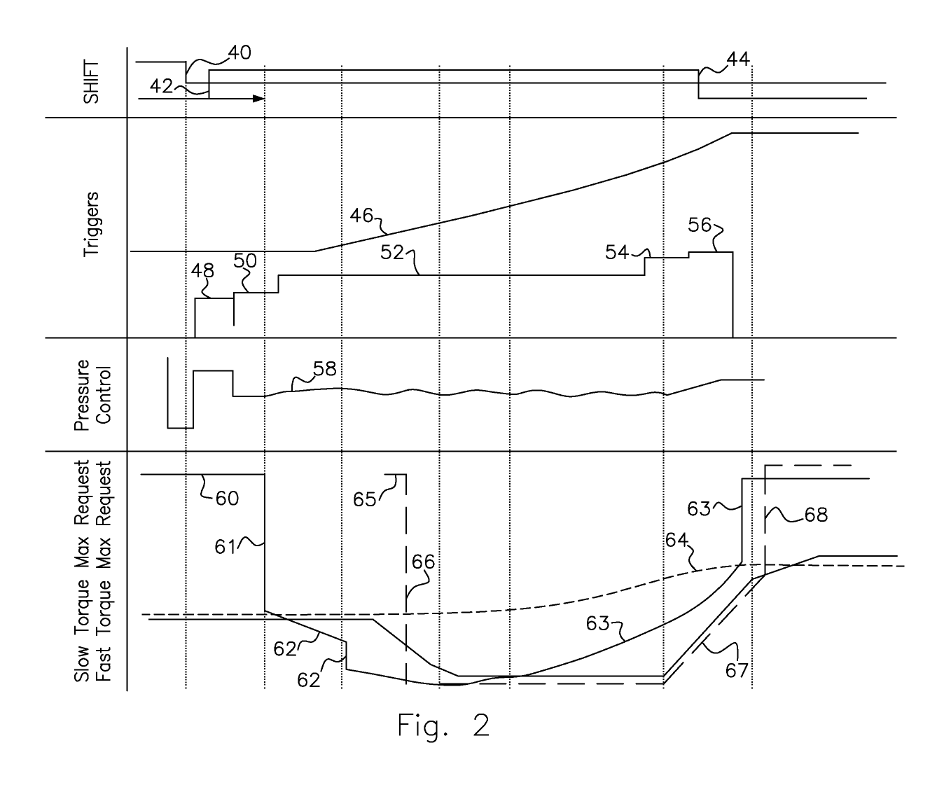

Referring to FIG. 2, a downshift is commanded at 40, and a trigger timer is initiated at 42 and terminated at 44.

The variation during the downshift of the extent to which the gearshift is completed is represented by graph 46 (Sft_pct_complete).

The gearshift phases that occur during the downshift include (i) start shift phase 48 wherein the oncoming transmission control element is prepared for engagement by rapidly pressurizing its hydraulic servo briefly to remove dimensional clearances and then reducing that pressure; (ii) torque transfer phase 50, wherein torque carried by the offgoing transmission control element is decreased and transferred to the oncoming transmission control element; (iii) ratio change phase 52, wherein the transmission speed ratio changes; shift end phase 54, wherein the oncoming control element is fully engaged and pressure in the offgoing element is vented; and gear shift termination phase 56.

Graph 58 shows the variation of servo pressure in the oncoming transmission control element during the downshift.

Graph 60, representing a slow actuator response to an input torque reduction request, includes a stepwise torque reduction 61 and a ramp reduction when triggered by shift percent complete 46, followed by another stepwise reduction 62 and a stepwise increase 63 to the original input torque magnitude, when input torque response exceeds the requested input torque 64.

Graph 65, representing a fast actuator response to an input torque reduction request, includes a stepwise torque reduction 66, followed by a ramped linear increase 67, and a stepwise increase 68 to the original input torque magnitude, when input torque response exceeds the requested input torque 64.

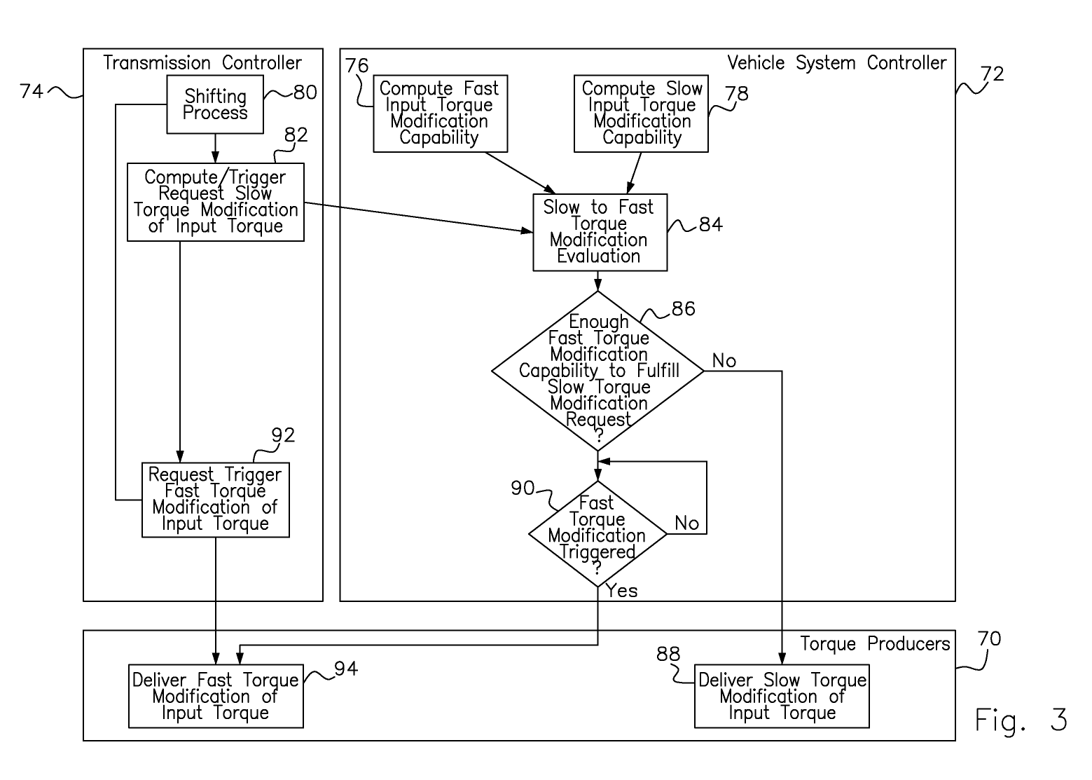

The steps of the algorithm shown in FIG. 3 are executed by power sources 70 capable of slow response and fast response to a command or request for input torque modification, a vehicle system controller 72, and a transmission controller 74.

At step 76, controller 72 computes the capability of powertrain 10 to produce a fast modification of input torque, and at step 78 the controller computes the capability of the powertrain to produce a slow modification of input torque. After a gearshift in transmission 24 begins at step 80, transmission controller 74 triggers a request for a slow torque modification of input torque.

Slow to fast torque input torque modification is evaluated at step 84.

A test is performed at step 86 to determine whether powertrain 10 is able to produce fast input torque modification in response to the request for slow input torque modification produced at step 82.

If the result of test 86 is logically negative, a slow actuator is promptly given lead time to react to the request for slow input torque modification so that the slow input torque modification is ready when needed to compensate for inertia effects at step 88.

If the result of test 86 is logically positive, a test is performed at step 90 to determine whether a request for fast input torque modification has been triggered by transmission controller 74 at step 92. The requests triggered at step 82 and 92 allow inertia effects of the gearshift to be compensated by reduction or increase of input torque. A slow actuator requires addition time, whereas a fast actuator does not require additional time.

If the result of test 90 is negative, control returns to step 90.

If the result of test 90 is positive, a fast modification of input torque is produced at step 94. As illustrated, the step 94 results from the fast modification of input torque or the slow to fast torque modification of input torque.

When internal combustion engine 12 is producing input torque, adjusting the throttle opening is slow actuation, whereas adjusting ignition timing or spark is fast actuation. In a hybrid electric powertrain, switching the electric machine 16 to operate as a motor produces fast input torque modification in response to a request for increased input torque. Switching the electric machine 16 to operate as a generator produces fast input torque modification in response to a request for input torque reduction.

In accordance with the provisions of the patent statutes, the preferred embodiment has been described. However, it should be noted that the alternate embodiments can be practiced otherwise than as specifically illustrated and described.

The invention claimed is:

1. A method for controlling torque modification during a gearshift, comprising:
(a) modifying transmission input torque during a gearshift using an actuator having slower and faster responses to a request for slow input torque modification;
(b) fulfilling the request using the slower response provided the faster response is unable to fulfill the request;
(c) fulfilling the request using the faster response, provided the faster response can provide the requested input torque modification.

2. The method of claim 1, further comprising performing input torque modification using the faster response, provided the faster response can timely provide the requested input torque modification.

3. The method of claim 1, wherein step (a) further comprises using a transmission having an input driveably connected to at least one power source and an output driveably connected to vehicle wheels.

4. The method of claim 3 further comprising:
performing a downshift; and
reducing transmission input torque produced by said at least one power source.

5. The method of claim 3 further comprising:
performing an upshift; and
increasing transmission input torque produced by said at least one power source.

6. The method of claim 3, further comprising:
using an internal combustion engine as the power source;
using an engine throttle position as the actuator having the slower response to the request; and
using engine ignition timing as the actuator having the faster response to the request.

7. The method of claim 3, comprising:
using an electric machine as the power source;
operating the electric machine as a motor to increase transmission input torque; and
operating the electric machine as a generator to decrease transmission input torque.

8. A method for controlling torque modification during a gearshift, comprising:
(a) modifying transmission input torque during a gearshift using an internal combustion engine having first and second actuators, the first actuator having a slower response to a request for input torque modification, the second actuator having a faster response to said request;
(b) fulfilling the request using the slower response provided the faster response is unable to fulfill the request;
(c) fulfilling the request using the faster response, provided the faster response can provide the requested input torque modification.

9. The method of claim 8, further comprising performing input torque modification using the faster response, provided the faster response can timely provide the requested torque modification.

10. The method of claim 8, wherein step (a) further comprises using a transmission having an input driveably connected to said engine and an output driveably connected to vehicle wheels.

11. The method of claim 10 further comprising:
performing a downshift; and
reducing transmission input torque produced by said engine.

12. The method of claim 10 further comprising:
performing an upshift; and
increasing transmission input torque produced by said engine.

13. The method of claim 8, wherein step (b) further comprises:
using an engine throttle position as the actuator having the slower response to the request; and
using engine ignition timing as the actuator having the faster response to the request.

14. A method for controlling torque modification during a gearshift, comprising:
(a) modifying transmission input torque during the gearshift using an actuator having slower and faster responses to a request for slow input torque modification;
(b) fulfilling the request using the slower response provided the faster response is unable to fulfill the request;
(c) fulfilling the request using the faster response, provided the faster response can provide the requested input torque modification;
(d) fulfilling a request for fast input torque modification using the faster response.

15. The method of claim 14, further comprising performing input torque modification using the faster response, provided the faster response can timely provide the requested input torque modification.

16. The method of claim 14, wherein step (a) further comprises using a transmission having an input driveably connected to at least one power source and an output driveably connected to vehicle wheels.

17. The method of claim 16 further comprising:
performing a downshift; and
reducing transmission input torque produced by said at least one power source.

18. The method of claim 16 further comprising:
performing an upshift; and
increasing transmission input torque produced by said at least one power source.

19. The method of claim 16, further comprising:
using an internal combustion engine as the power source;
using an engine throttle position as the actuator having the slower response to the request; and
using engine ignition timing as the actuator having the faster response to the request.

20. The method of claim 16, further comprising:
using an electric machine as the power source;
operating the electric machine as a motor to increase transmission input torque; and
operating the electric machine as a generator to decrease transmission input torque.
